(19) United States
(12) Patent Application Publication
(10) Pub. No.: US 2026/0222843 A1
(43) Pub. Date: Jul. 30, 2026

(54) METHOD AND APPARATUS FOR TRANSMITTING AND RECEIVING INFORMATION

(71) Applicant: 1FINITY Inc., Kawasaki-shi (JP)

(72) Inventors: Yujia SHAN, Beijing (CN); Xin WANG, Beijing (CN); Guorong LI, Beijing (CN); Su YI, Beijing (CN); Meiyi JIA, Beijing (CN)

(73) Assignee: 1FINITY Inc., Kawasaki-shi (JP)

(21) Appl. No.: 19/629,148

(22) Filed: Mar. 26, 2026

Related U.S. Application Data
(63) Continuation of application No. PCT/CN2023/122297, filed on Sep. 27, 2023.

(51) Int. Cl. H04W 24/02; H04B 17/309; H04B 17/318; H04L 41/16

(52) U.S. Cl. CPC H04W 24/02; H04B 17/328; H04B 17/346; H04L 41/16

(57) ABSTRACT

A method and apparatus for transmitting and receiving information. Including: receiving first configuration information by a first network device from a second network device, the first configuration information being used for data collection configuration; receiving first information and/or second information by the first network device from the second network device, the first information and the second information being related to data collection, the first information is at least used to generate a measurement configuration, and the second information is at least used to generate a data report configuration related to the measurement; and transmitting third information by the first network device to the second network device, the third information being at least used for suggestions and/or feedback of the data collection configuration given by the second network device.

### CROSS-REFERENCE TO RELATED APPLICATION

This application is a continuation application under 35 U.S.C. 111(a) of International Patent Application PCT/CN2023/122297 filed on Sep. 27, 2023, and designated the U.S., the entire contents of which are incorporated herein by reference.

### TECHNICAL FIELD

This disclosure relates to the field of communication technologies.

### BACKGROUND

With the commercialization of 5G technology, especially the large-scale expansion of the industrial Internet industry, in the field of wireless communications, there are many use cases of using AI (artificial intelligence) and ML (machine learning) algorithms to improve performance, such as using AI for CSI (channel state information) compression feedback, beam management, and wireless positioning, etc.

Currently, artificial intelligence algorithms represented by deep learning need to collect large amounts of data during model training and other stages. In wireless communication, such data are typically physical measurement quantities in some wireless channels, and need to be obtained via channel measurement reports between base stations, high layer networks (such as operation administration and maintenance (OAM)) and terminal equipments (UEs).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In artificial intelligence/machine learning (AI/ML) applications, there exists a model deployed in a base station. An offline training part of this model is deployed in the base station or a high layer network, such as OAM. If a training position is at the OAM, the base station and/or a terminal equipment need(s) to report data required by the OAM to the OAM; and if the training position is at the base station, data may be collected for the base station via a data collection mechanism in which the OAM is involved.

However, it was found by the inventor that in an existing OAM data collection framework and/or process, signaling is unable to support requirements of the model training for data, hence, new signaling and mechanisms need to be added.

In order to solve one or more of the above-mentioned problems, embodiments of this disclosure provide a method and apparatus for transmitting and receiving information.

According to a first aspect of the embodiments of this disclosure, there is provided a method for transmitting and receiving information, the method including: receiving first configuration information by a first network device from a second network device, the first configuration information being used for data collection configuration; receiving first information and/or second information by the first network device from the second network device, the first information and the second information being related to data collection, the first information is at least used to generate a measurement configuration, and the second information is at least used to generate a data report configuration related to the measurement; and transmitting third information by the first network device to the second network device, the third information being at least used for suggestions and/or feedback of the data collection configuration given by the second network device.

According to a second aspect of the embodiments of this disclosure, there is provided a method for transmitting and receiving information, the method including: transmitting first configuration information by a second network device to a first network device, the first configuration information being used for data collection configuration; transmitting first information and/or second information by the second network device to the first network device, the first information and the second information being related to data collection, the first information is at least used to generate a measurement configuration, and the second information is at least used to generate a data report configuration related to the measurement; and receiving third information by the second network device from the first network device, the third information being at least used to provide suggestions and/or feedback of the data collection configuration to the second network device.

According to a third aspect of the embodiments of this disclosure, there is provided an apparatus for transmitting and receiving information, provided in a first network device, the apparatus including: a first receiving unit configured to receive first configuration information from a second network device, the first configuration information being used for data collection configuration, and receive first information and/or second information from the second network device, the first information and the second information being related to data collection, the first information is at least used to generate a measurement configuration, and the second information is at least used to generate a data report configuration related to the measurement; and a first transmitting unit configured to transmit third information to the second network device, the third information being at least used for a suggestion and/or feedback of the data collection configuration given by the second network device.

According to a fourth aspect of the embodiments of this disclosure, there is provided an apparatus for transmitting and receiving information, provided in a second network device, the apparatus including: a second transmitting unit configured to transmit first configuration information to a first network device, the first configuration information being used for data collection configuration, and transmit first information and/or second information to the first network device, the first information and the second information being related to data collection, the first information is at least used to generate a measurement configuration, and the second information is at least used to generate a data report configuration related to the measurement; and a second receiving unit configured to receive third information from the first network device, the third information being at least used to provide suggestions and/or feedback of the data collection configuration to the second network device.

According to a fifth aspect of the embodiments of this disclosure, there is provided a computer readable program, which, when executed in an apparatus for transmitting and receiving information or a first network device, will cause the apparatus for transmitting and receiving information or the first network device to carry out the method for transmitting and receiving information as described in the embodiment of the first aspect of this disclosure.

According to a sixth aspect of the embodiments of this disclosure, there is provided a computer readable program, which, when executed in an apparatus for transmitting and receiving information or a second network device, will cause the apparatus for transmitting and receiving information or the second network device to carry out the method for transmitting and receiving information as described in the embodiment of the second aspect of this disclosure.

According to a seventh aspect of the embodiments of this disclosure, there is provided a computer readable medium, including a computer readable program, which will cause an apparatus for transmitting and receiving information or a first network device to carry out the method for transmitting and receiving information as described in the embodiment of the first aspect of this disclosure.

According to an eighth aspect of the embodiments of this disclosure, there is provided a computer readable medium, including a computer readable program, which will cause an apparatus for transmitting and receiving information or a second network device to carry out the method for transmitting and receiving information as described in the embodiment of the second aspect of this disclosure.

An advantage of the embodiments of this disclosure exists in that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a method for transmitting and receiving information of the embodiment of this disclosure;

FIG. 3 is an interaction graph of an implementation of the method for transmitting and receiving information of the embodiment of this disclosure;

FIG. 4 is an interaction graph of another implementation of the method for transmitting and receiving information of the embodiment of this disclosure;

FIG. 5 is an interaction graph of a further implementation of the method for transmitting and receiving information of the embodiment of this disclosure;

FIG. 6 is another schematic diagram of the method for transmitting and receiving information of the embodiment of this disclosure;

FIG. 7 is a schematic diagram of an apparatus for transmitting and receiving information of an embodiment of this disclosure;

FIG. 8 is another schematic diagram of the apparatus for transmitting and receiving information of the embodiment of this disclosure;

FIG. 9 is a block diagram of a systematic structure of a first network device of an embodiment of this disclosure; and

FIG. 10 is a block diagram of a systematic structure of a second network device of an embodiment of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, as well as 5G, 5G-Advanced, New Radio (NR) and 6G in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a node and/or donor in an IAB architecture, a base station (BS), an access point (AP), a transmission reception point (TRP), a broadcast transmitter, a mobile management entity (MME), a gateway, a server, a radio network controller (RNC), a base station controller (BSC), etc.

In the embodiments of this disclosure, the base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. For example, a 5G base station gNB may include a gNB CU and one or more gNB DUs, wherein the CU/DU is a logical node of the gNB having a part of functions of the gNB. And a term “cell” may refer to a base station and/or its coverage area, depending on a context of the term.

In the embodiments of this disclosure, ‘a network device’ may further include a network device or a network element of a core network and/or a higher layer network, such as OAM.

For example, the core network includes an EPC (corresponding to a 4G core network) and/or a 5GC (corresponding to a 5G core network);
the EPC includes but is not limited to the following network elements: an MME (mobility management entity), an SGW (serving gateway), a PGW (PDN gateway), and a PCRF (policy and charging rules function), etc.;
the 5GC includes but is not limited to the following network elements: an AMF (access and mobility management function), an LMF (location management function), an SMF (session management function), a UPF (user plane function), aPCF (policy control function), UDM (unified data management), an AUSF (authentication server function), and a UDR (unified data repository), etc.

In the embodiments of this disclosure, the term “user equipment (UE)” or “a terminal equipment (TE) or terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment.

Scenarios of the embodiments of this disclosure shall be described below by way of examples; however, this disclosure is not limited thereto.

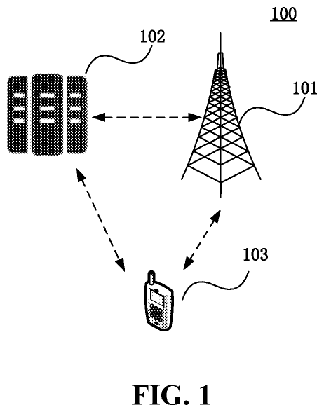

FIG. 1 is a schematic diagram of a communication system of this disclosure. As shown in FIG. 1, a communication system 100 may include a first network device 101, a second network device 102 and a terminal equipment 103. For the sake of simplicity, an example having only one terminal equipment and one network device is schematically given in FIG. 1; however, the embodiments of this disclosure are not limited thereto.

In the embodiments of this disclosure, the first network device 101 is, for example, a base station, such as a gNB, and the second network device 102 is, for example, OAM.

In the embodiments of this disclosure, in various applications of AI/ML air interface, for an AI/ML model deployed at the terminal equipment side 103 (UE side), tasks that AI/ML needs to complete may be defined by functionalities, and capabilities and conditions of whether the AI/ML model supports may be indirectly determined.

For example, the functionalities may be defined by more specific concept features or feature groups. Final operations of the AI/ML model (such as selection, activation, deactivation, switching) will be determined by functionalities configured by the network side, and the selection of the functionalities themselves needs to be determined after information exchange between the network device (such as the first network device 101 and/or the second network device 102) and the terminal equipment.

In the embodiments of this disclosure, existing services or services that may be implemented in the future may be performed between the network device 101 and the terminal equipment 103. For example, such services may include but not limited to an enhanced mobile broadband (eMBB), massive machine type communication (MTC), and ultra-reliable and low-latency communication (URLLC), etc.

In the embodiments of this disclosure, high layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

### Embodiment of a First Aspect

The embodiments of this disclosure provide a method for transmitting and receiving information, which shall be described from a first network side.

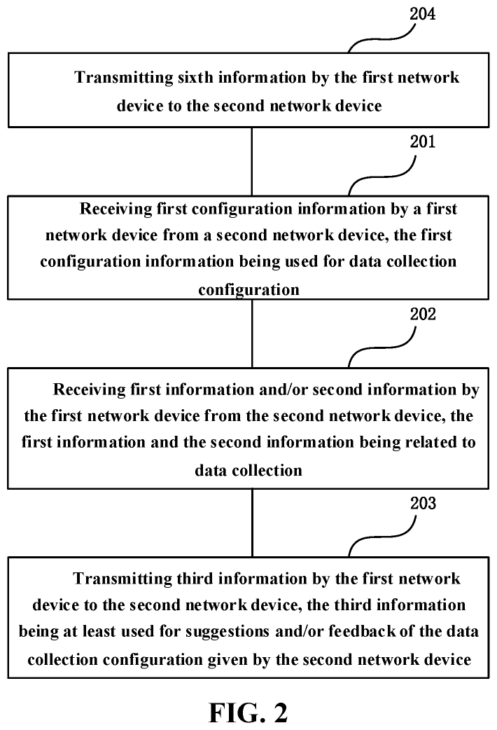

FIG. 2 is a schematic diagram of the method for transmitting and receiving information of the embodiment of this disclosure. As shown in FIG. 2, the method includes:
201: receiving first configuration information by a first network device from a second network device, the first configuration information being used for data collection configuration;
202: receiving first information and/or second information by the first network device from the second network device, the first information and the second information being related to data collection, the first information is at least used to generate a measurement configuration, and the second information is at least used to generate a data report configuration related to the measurement; and
203: transmitting third information by the first network device to the second network device, the third information being at least used for suggestions and/or feedback of the data collection configuration given by the second network device.

It should be noted that FIG. 2 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 2.

In some embodiments, an order of execution of operations 201 and 202 is not limited in this method.

In the embodiments of this disclosure, the first network device 101 is, for example, a base station, such as a gNB, and the second network device 102 is, for example, OAM.

In operation 201, the first network device receives the first configuration information for data collection configuration from the second network device.

For example, the data collection refers to a process of report of measurement and data.

In some embodiments, the first configuration information includes one or more of measurement contents, data quality information and other data collection information.

In some embodiments, the first configuration information includes existing measurement content, and the first information includes measurement content different from the existing measurement content.

In some embodiments, the first information is transmitted as an optional part of the first configuration information, or the first information is transmitted separately and not transmitted with the first configuration information.

In some embodiments, the first information specifies measurement content in a bitmap mode.

Specifying the measurement contents in a bitmap mode shall be described first.

For example, the first information includes N binary bits, each bit indicating a measurement content. When the bit is a specific value (such as 0 or 1), it indicates that the second network device configures the first network device to acquire a measurement result to which the measurement content indicated by the bit corresponds; where, N is a positive integer, for example, N is 8; however, the embodiments of this disclosure are not limited thereto.

Table 1 is an example of the first information of the measurement contents specified in a bitmap mode In the embodiments of this disclosure. As shown in Table 1, the bitmap includes 8 bits, in which BIT1-BIT7 are used to specify measurement contents Meas1-Maas7, Meas1-Maas7 representing different measurement contents. For example, Meas1 represents a measurement content, which may be used to indicate existing technologies (such as RSRP) already given in 38.215, as well as measurement contents (such as CIR) that may be introduced in 38.215 or other protocols in the future for wireless channel signal quality.

TABLE 1
M1 Measurement

| BIT8 | BIT7 | BIT6 | BIT5 | BIT4 | BIT3 | BIT2 | BIT1 |
|---|---|---|---|---|---|---|---|
| Reserved | Meas7 | Meas6 | Meas5 | Meas4 | Meas3 | Meas2 | Meas1 |

The above is an example of a bitmap used to specify a measurement content. A correspondence between rows and columns, number of bits, measurement content and presentation forms of the bit are not limited In the embodiments of this disclosure.

In some embodiments, the measurement content is transmitted as a part of existing configuration signaling, or the data measurement content is transmitted separately and not transmitted with the existing configuration signaling.

For example, for application scenarios of wireless data collection, such as minimization drive test (MDT), the first configuration information specifying the data measurement contents may be carried by signaling in a wireless data collection framework, such as MDT, for example, it is taken as a part of MDT configuration, and transmitted by OAM to the base station; or, it may also be carried by other signaling.

In some embodiments, the measurement contents specified by the first information in a bitmap mode include location information. That is, the first information may specify the location information in a bitmap mode.

Next, specifying the location information in a bitmap mode shall be described in detail.

For example, the first information contains N binary bits, each bit indicating a type of location information. When the bit is a specific value (such as 0 or 1), it indicates that the second network device configures the first network device to acquire a measurement result to which the location information indicated by the bit corresponds; where, N is a positive integer, for example, N is 8; however, the embodiments of this disclosure are not limited thereto.

Table 2 is an example of specifying the location information in a bitmap mode In the embodiments of this disclosure. As shown in Table 2, the bitmap includes 8 bits, in which BIT1-BIT8 are used to specify different location information. In the related art, WLAN location measurement is configured separately, and only a GNSS positioning method may be selected besides WLAN. In the embodiments of this disclosure, more selectable measurement methods are added.

TABLE 2
NR Positioning

| BIT8 | BIT7 | BIT6 | BIT5 | BIT4 | BIT3 | BIT2 | BIT1 |
|---|---|---|---|---|---|---|---|
| AI/ML | AI/ML | AoA | Multi- | UL- | DL- | E-Cell | GNSS |
| Assisted | Direct | | RTT | TDOA | TDOA | ID | |

SPARE

The above is an example of a bitmap used to specify location information. A correspondence between rows and columns, number of bits, location information and presentation forms of the bit are not limited In the embodiments of this disclosure.

For example, for application scenarios of wireless data collection, such as MDT, the first configuration information specifying the location information may be carried by signaling in a wireless data collection framework, such as MDT, and transmitted by OAM to the base station.

In some embodiments, operation 202 may be performed before operation 201.

In operation 202, the first network device receives the first information and/or the second information from the second network device, and the first information and the second information are related to data collection.

In some embodiments, a measurement result and/or data obtained by the first network device according to the first information and/or the second information are used for a wireless communication artificial intelligence/machine learning (AI/ML) application.

In some embodiments, the measurement is measurement related to a wireless channel performed by a terminal equipment configured by the first network device,
the measurement configuration is related to content of the measurement, and the measurement configuration is generated at least by the first network device based on the first information, the content of the measurement at least comprising a measurement metric,
and the data report configuration is related to a means on how the first network device configures the terminal equipment to transmit a measurement result and/or data to the first network device, the means being generated at least by the first network device according to the second information.

For example, the measurement metric is one or more of the following:
RSRP, RSRQ, an SINR, a TDOA, a TOA, an AoA, a channel LOS/NLOS probability, a maximum value of RSRP, a maximum value of RSRQ, a maximum value of an SINR, a maximum value of a TDOA, a maximum value of a TOA, a maximum value of an AoA, a maximum value of a channel LOS/NLOS probability, a minimum value of RSRP, a minimum value of RSRQ, a minimum value of an SINR, a minimum value of a TDOA, a minimum value of a TOA, a minimum value of an AoA, a minimum value of a channel LOS/NLOS probability, a mean value of RSRP, a mean value of RSRQ, a mean value of an SINR, a mean value of a TDOA, a mean value of a TOA, a mean value of an AoA, a mean value of a channel LOS/NLOS probability, a median value of RSRP, a median value of RSRQ, a median value of an SINR, a median value of a TDOA, a median value of a TOA, a median value of an AoA, a median value of a channel LOS/NLOS probability, other statistical values of RSRP, other statistical values of RSRQ, other statistical values of an SINR, other statistical values of a TDOA, other statistical values of a TOA, other statistical values of an AoA, or other statistical values of a channel LOS/NLOS probability.

In some embodiments, the third information is used for the second network device to generate a data collection configuration, a content of a generated data collection configuration comprising at least one of contents of updated first configuration information, updated first information or updated second information, or maintaining original configuration information unchanged.

A situation where the first network device receives the first information from the second network device shall be described in detail first.

In some embodiments, the first information is related to measurement, for example, the first information is at least used to generate a measurement configuration. For example, the first information includes such information as quality, and an amount of samples, etc.

In some embodiments, the first network device reports relevant information to the second network device according to the received first information.

In operation 203, the first network device transmits the third information to the second network device, the third information being at least used for suggestions and/or feedback of the data collection configuration given by the second network device. For example, after the data collection configuration given by the second network device is obtained in operation 201, the first network device transmits a suggestion and/or feedback of the data collection configuration to the second network device.

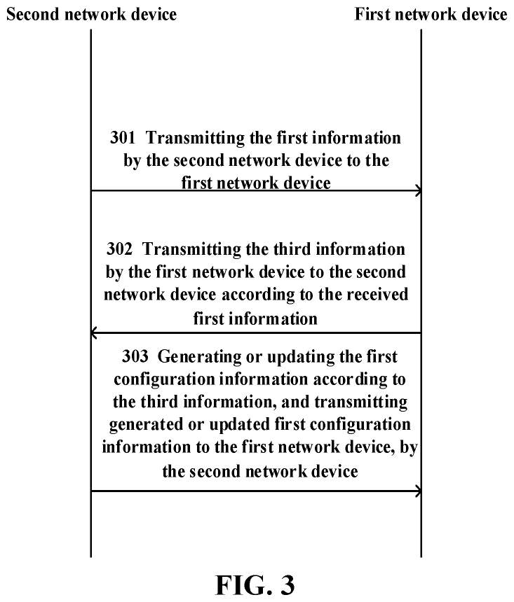

FIG. 3 is an interaction graph of an implementation of the method for transmitting and receiving information of the embodiment of this disclosure. As shown in FIG. 3, the method includes:
301: transmitting the first information by the second network device to the first network device, the first information being at least used to generate a measurement configuration;
302: transmitting the third information by the first network device to the second network device according to the received first information, the third information being at least used for a suggestion and/or feedback of the data collection configuration given by the second network device; and
303: generating or updating the first configuration information according to the third information, and transmitting generated or updated first configuration information to the first network device, by the second network device.

In some embodiments, the third information includes information of the first network device and/or a request for configuration information for configuring data collection.

In some embodiments, the information of the first network device includes one or more pieces of data information, model information or capability information of the first network device.

In some embodiments, the configuration information for configuring data collection may be identical to or partially identical to the first configuration information, or may be different from the first configuration information.

In operation 301, the second network device transmits the first information to the first network device, for example, OAM transmits additional signaling to the base station, requesting the base station to report information of its own. The additional signaling is, for example, signaling out of the measurement configuration.

In operation 302, the first network device transmits the third information to the second network device according to the received first information. For example, the base station feeds the third information including the information of the first network device and/or the request for the configuration information for configuring data collection back to the OAM according to the additional signaling transmitted by the OAM.

In operation 303, in some embodiments, the second network device may generate or update the first configuration information according to the third information, and transmit the generated or updated first configuration information to the first network device, thereby configuring data collection according to feedback from the base station side.

In some embodiments, after receiving the first information, the first network device may interact with the terminal equipment.

In some embodiments, the first network device transmits fourth information to the terminal equipment after receiving the first information, and receives fifth information from the terminal equipment.

In some embodiments, the fourth information is used to instruct the terminal equipment to transmit the fifth information to the first network device, and/or, the fourth information indicates a content of the fifth information, the indicated content comprising at least one piece of the following information: model identification information, functionality identification information, or information on a feature and/or a feature group related to a model or functionality;
for example, the fourth information may be transmitted via RRC signaling or MAC CE signaling or DCI.

In some embodiments, the fifth information includes capability information related to AI/ML of the terminal equipment and/or condition information on performing data collection related to AI/ML of the terminal equipment.

In some embodiments, the third information is generated according to one or more of the first information, the second information or the fifth information.

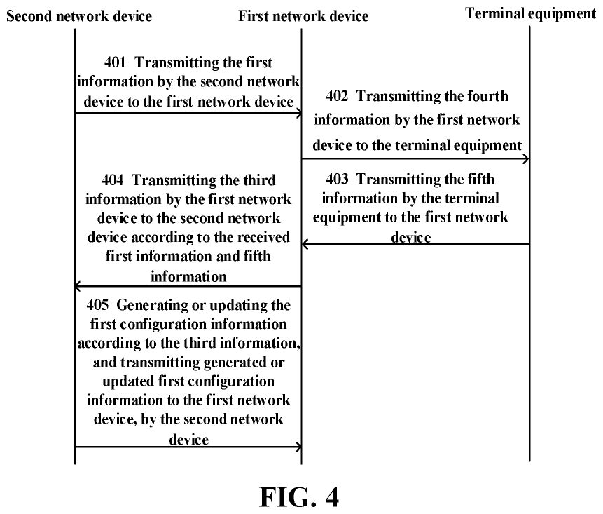

FIG. 4 is an interaction graph of another implementation of the method for transmitting and receiving information of the embodiment of this disclosure. As shown in FIG. 4, the method includes:
401: transmitting the first information by the second network device to the first network device;
402: transmitting the fourth information by the first network device to the terminal equipment;
403: transmitting the fifth information by the terminal equipment to the first network device;
404: transmitting the third information by the first network device to the second network device according to the received first information and fifth information; and
405: generating or updating the first configuration information according to the third information, and transmitting generated or updated first configuration information to the first network device, by the second network device.

After the first network device receives the first information, interaction is performed between the first network device and the terminal equipment in operations 402 and 403. For example, the first network device transmits the fourth information to the terminal equipment, requesting the terminal equipment to feed back the fifth information.

Next, a situation where the first network device receives the second information from the second network device shall be described in detail.

In some embodiments, the second information is related to data reporting, for example, the second information is related to a condition for data reporting. For example, data reporting is performed when the condition is satisfied, and only feedback is performed and data reporting is not performed when the condition is not satisfied.

In some embodiments, the first network device reports relevant information to the second network device according to the received second information.

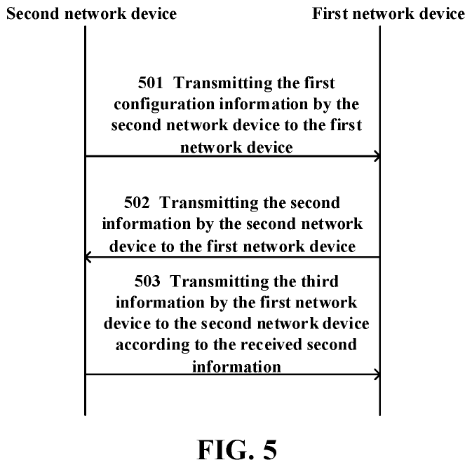

FIG. 5 is an interaction graph of a further implementation of the method for transmitting and receiving information of the embodiment of this disclosure. As shown in FIG. 5, the method includes:
501: transmitting the first configuration information by the second network device to the first network device;
502: transmitting the second information by the second network device to the first network device; and
503: transmitting the third information by the first network device to the second network device according to the received second information.

In some embodiments, operations 501 and 502 may be executed sequentially or simultaneously.

In operations 502 and 503, for example, the OAM transmits the second information related to the condition for data reporting to the base station. After receiving the second information, the base station reports the data when the condition is satisfied, that is, the third information transmitted to the OAM includes the reported data, and feeds back only to the OAM and does not report data when the condition is not satisfied, that is, the sixth information transmitted to the OAM only includes feedback information for the second information and does not include the reported data.

In some embodiments, after receiving the second information, the first network device may interact with the terminal equipment, and a process thereof is similar to the process of interaction between the first network device and the terminal equipment shown in FIG. 4. Reference may made to relevant operations in FIG. 4, which shall not be repeated herein any further.

In some embodiments, the process of receiving the second information and feeding back the third information to the first network device by the first network device may be continuously repeated and updated.

In some embodiments, the second information includes a mode for reporting data, the data come from the terminal equipment and are acquired by the terminal equipment via wireless channel measurement according to the configuration information of the first network device.

In some embodiments, the means for reporting data comprises aggregated reporting and/or periodic reporting and/or reporting according to a logging pattern.

In some embodiments, the mode for reporting data is included in the above second information, or mode for reporting data may not be included in the second information, for example, it is transmitted separately.

For example, for the centralized reporting, the first network device may configure a threshold of amount of samples and/or a sample size threshold. The terminal equipment stores measurement results and/or data before the threshold(s) is/are satisfied, and reports them uniformly after the threshold(s) is/are satisfied.

For example, for the periodic reporting, the first network device may configure a period of reporting of the terminal equipment, and the terminal equipment regularly reports measurement results and/or data according to the configured period.

For example, for the reporting according to a logging pattern, the first network device may configure the terminal equipment to store measurement results in a form of logging for a period of time and upload log files according to the configuration.

In some embodiments, as shown in FIG. 2, before operations 201 and 202, the method further includes:
204: transmitting sixth information by the first network device to the second network device,
the sixth information being used to request the second network device to initiate a data collection process and/or perform data collection configuration, the process and the configuration being used for wireless communication artificial intelligence/machine learning (AI/ML) or other applications.

In some embodiments, operation 204 is optional.

In some embodiments, the sixth information may further include all or a part of information in the third information, such as the information of the first network device.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Second Aspect

The embodiments of this disclosure provide a method for transmitting and receiving information, which shall be described from a second network device side. This embodiment corresponds to the embodiment of the first aspect, and contents in this embodiment identical to those in the embodiment of the first aspect shall not be described herein any further.

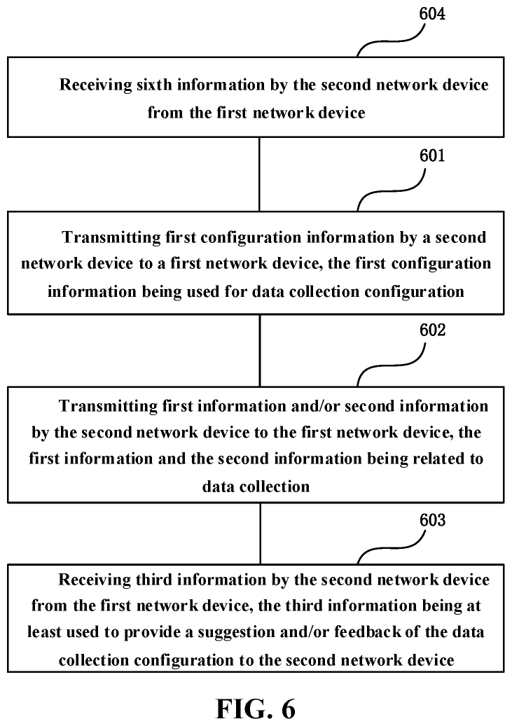

FIG. 6 is another schematic diagram of the method for transmitting and receiving information of an embodiment of this disclosure. As shown in FIG. 6, the method includes:
601: transmitting first configuration information by a second network device to a first network device, the first configuration information being used for data collection configuration;
602: transmitting first information and/or second information by the second network device to the first network device, the first information and the second information being related to data collection, the first information is at least used to generate a measurement configuration, and the second information is at least used to generate a data report configuration related to the measurement; and
603: receiving third information by the second network device from the first network device, the third information being at least used to provide a suggestion and/or feedback of the data collection configuration to the second network device.

In some embodiments, the measurement is measurement related to a wireless channel performed by a terminal equipment configured by the first network device,
the measurement configuration is related to content of the measurement, and the measurement configuration is generated at least by the first network device based on the first information, the content of the measurement at least comprising a measurement metric,
and the data report configuration is related to a means on how the first network device configures the terminal equipment to transmit a measurement result and/or data to the first network device, the means being generated at least by the first network device according to the second information.

In some embodiments, the third information is used for the second network device to generate a data collection configuration, a content of a generated data collection configuration comprising at least one of contents of updated first configuration information, updated first information or updated second information, or maintaining original configuration information unchanged.

In some embodiments, the second information includes a mode for reporting data, wherein the data come from the terminal equipment and are acquired by the terminal equipment via wireless channel measurement according to the configuration information of the first network device.

In some embodiments, the means for reporting data comprises aggregated reporting and/or periodic reporting and/or reporting according to a logging pattern.

In some embodiments, the first configuration information includes existing measurement content, and the first information includes measurement content different from the existing measurement content.

In some embodiments, the method further includes:
604: receiving sixth information from the first network device,
the sixth information being used to request the second network device to initiate a data collection process and/or perform data collection configuration, the process and the configuration being used for wireless communication artificial intelligence/machine learning (AI/ML) or other applications.

Reference may be made to the disclosure contained in the embodiment of the first aspect for specific contents of the above operations, which shall not be repeated herein any further.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Third Aspect

The embodiments of this disclosure provide an apparatus for transmitting and receiving information. The apparatus may be, for example, a first network device, or one or some components or assemblies configured in the first network device. This embodiment corresponds to the embodiment of the first aspect, and contents in this embodiment identical to those in the embodiment of the first aspect shall not be described herein any further.

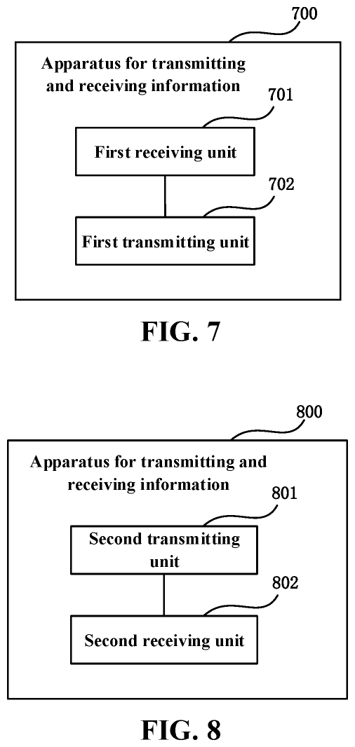

FIG. 7 is a schematic diagram of the apparatus for transmitting and receiving information of an embodiment of this disclosure. As shown in FIG. 7, an apparatus 700 for transmitting and receiving information includes:
a first receiving unit 701 configured to receive first configuration information from a second network device, the first configuration information being used for data collection configuration, and receive first information and/or second information from the second network device, the first information and the second information being related to data collection, the first information is at least used to generate a measurement configuration, and the second information is at least used to generate a data report configuration related to the measurement; and
a first transmitting unit 702 configured to transmit third information to the second network device, the third information being at least used for a suggestion and/or feedback of the data collection configuration given by the second network device.

In some embodiments, a measurement result and/or data obtained by the first network device according to the first information and/or the second information are used for a wireless communication artificial intelligence/machine learning (AI/MiL) application.

In some embodiments, the measurement is measurement related to a wireless channel performed by a terminal equipment configured by the first network device,
the measurement configuration is related to content of the measurement, and the measurement configuration is generated at least by the first network device based on the first information, the content of the measurement at least comprising a measurement metric,
and the data report configuration is related to a means on how the first network device configures the terminal equipment to transmit a measurement result and/or data to the first network device, the means being generated at least by the first network device according to the second information.

In some embodiments, the measurement metric is one or more of the following:
RSRP, RSRQ, an SINR, a TDOA, a TOA, an AoA, a channel LOS/NLOS probability, a maximum value of RSRP, a maximum value of RSRQ, a maximum value of an SINR, a maximum value of a TDOA, a maximum value of a TOA, a maximum value of an AoA, a maximum value of a channel LOS/NLOS probability, a minimum value of RSRP, a minimum value of RSRQ, a minimum value of an SINR, a minimum value of a TDOA, a minimum value of a TOA, a minimum value of an AoA, a minimum value of a channel LOS/NLOS probability, a mean value of RSRP, a mean value of RSRQ, a mean value of an SINR, a mean value of a TDOA, a mean value of a TOA, a mean value of an AoA, a mean value of a channel LOS/NLOS probability, a median value of RSRP, a median value of RSRQ, a median value of an SINR, a median value of a TDOA, a median value of a TOA, a median value of an AoA, a median value of a channel LOS/NLOS probability, other statistical values of RSRP, other statistical values of RSRQ, other statistical values of an SINR, other statistical values of a TDOA, other statistical values of a TOA, other statistical values of an AoA, or other statistical values of a channel LOS/NLOS probability.

In some embodiments, the third information is used for the second network device to generate a data collection configuration, a content of a generated data collection configuration comprising at least one of contents of updated first configuration information, updated first information or updated second information, or maintaining original configuration information unchanged.

In some embodiments, the first transmitting unit further transmits fourth information to the terminal equipment after the first network device receives the first information,
and the first receiving unit further receives fifth information from the terminal equipment,
the fourth information is used to instruct the terminal equipment to transmit the fifth information to the first network device, and/or, the fourth information indicates a content of the fifth information, the indicated content comprising at least one piece of the following information: model identification information, functionality identification information, or information on a feature and/or a feature group related to a model or functionality,
and the fifth information comprises capability information related to AI/ML of the terminal equipment and/or condition information on performing data collection related to AI/ML of the terminal equipment.

In some embodiments, the apparatus further includes a first generating unit configured to generate the third information according to one or more of the first information, the second information and the fifth information.

In some embodiments, the second information includes a mode for reporting data, wherein the data come from a terminal equipment and are acquired by the terminal equipment via wireless channel measurement according to the configuration information of the first network device.

In some embodiments, the means for reporting data comprises aggregated reporting and/or periodic reporting and/or reporting according to a logging pattern.

In some embodiments, the first configuration information includes existing measurement content, and the first information includes measurement content different from the existing measurement content.

In some embodiments, the first information specifies measurement content in a bitmap mode.

In some embodiments, the first information is transmitted as an optional part of the first configuration information, or the first information is transmitted separately and not transmitted with the first configuration information.

In some embodiments, the first transmitting unit 702 further transmits sixth information to the second network device,
the sixth information being used to request the second network device to initiate a data collection process and/or perform data collection configuration, the process and the configuration being used for wireless communication artificial intelligence/machine learning (AI/ML) or other applications.

It should be noted that the components or modules related to this disclosure are only described above. However, this disclosure is not limited thereto, and the apparatus 700 for transmitting and receiving information may further include other components or modules, and reference may be made to related techniques for particulars of these components or modules.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited In the embodiments of this disclosure.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Fourth Aspect

The embodiments of this disclosure provide an apparatus for transmitting and receiving information. The apparatus may be, for example, a second network device, or one or some components or assemblies configured in the second network device. This embodiment corresponds to the embodiment of the second aspect, and contents in this embodiment identical to those in the embodiment of the second aspect shall not be described herein any further.

FIG. 8 is another schematic diagram of the apparatus for transmitting and receiving information of the embodiment of this disclosure. As shown in FIG. 8, an apparatus 800 for transmitting and receiving information includes:
a second transmitting unit 801 configured to transmit first configuration information to a first network device, the first configuration information being used for data collection configuration, and transmit first information and/or second information to the first network device, the first information and the second information being related to data collection, wherein the first information is at least used to generate a measurement configuration, and the second information is at least used to generate a data report configuration related to the measurement; and
a second receiving unit 802 configured to receive third information from the first network device, the third information being at least used to provide suggestions and/or feedback of the data collection configuration to the second network device.

In some embodiments, the measurement is measurement related to a wireless channel performed by a terminal equipment configured by the first network device,
the measurement configuration is related to content of the measurement, and the measurement configuration is generated at least by the first network device based on the first information, the content of the measurement at least comprising a measurement metric,
and the data report configuration is related to a means on how the first network device configures the terminal equipment to transmit a measurement result and/or data to the first network device, the means being generated at least by the first network device according to the second information.

In some embodiments, the third information is used for the second network device to generate a data collection configuration, a content of a generated data collection configuration comprising at least one of contents of updated first configuration information, updated first information or updated second information, or maintaining original configuration information unchanged.

In some embodiments, the second information includes a mode for reporting data, wherein the data come from a terminal equipment and are acquired by the terminal equipment via wireless channel measurement according to the configuration information of the first network device.

In some embodiments, the means for reporting data comprises aggregated reporting and/or periodic reporting and/or reporting according to a logging pattern.

In some embodiments, the first configuration information includes existing measurement content, and the first information includes measurement content different from the existing measurement content.

In some embodiments, the second receiving unit 802 further receives sixth information from the first network device,
the sixth information being used to request the second network device to initiate a data collection process and/or perform data collection configuration, the process and the configuration being used for wireless communication artificial intelligence/machine learning (AI/ML) or other applications.

Furthermore, for the sake of simplicity, connection relationships between the components or modules or signal profiles thereof are only illustrated in FIG. 8. However, it should be understood by those skilled in the art that such related techniques as bus connection, etc., may be adopted. And the above components or modules may be implemented by hardware, such as a processor, a memory, a transmitter, and a receiver, etc., which are not limited In the embodiments of this disclosure.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Fifth Aspect

The embodiments of this disclosure provide a network device, including the apparatus for transmitting and receiving information described in the embodiment of the third aspect. The network device is a first network device.

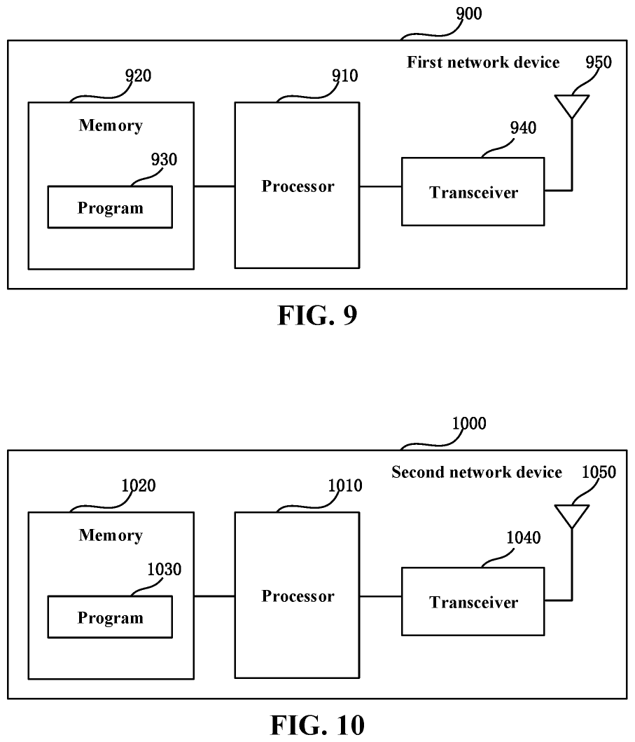

FIG. 9 is a block diagram of a systematic structure of the first network device of the embodiment of this disclosure. As shown in FIG. 9, a first network device 900 may include a processor 910 and a memory 920, the memory 920 being coupled to the processor 910. Wherein, the memory 920 may store various data, and furthermore, it may store a program 930 for information processing, and execute the program 930 under control of the processor 910.

In one implementation, functions of the apparatus for transmitting and receiving information may be integrated into the processor 910.

The processor 910 may be configured to: receive first configuration information from a second network device, the first configuration information being used for data collection configuration, receive first information and/or second information from the second network device, the first information and the second information being related to data collection, wherein the first information is at least used to generate a measurement configuration, and the second information is at least used to generate a data report configuration related to the measurement, and transmit third information to the second network device, the third information being at least used for a suggestion and/or feedback of the data collection configuration given by the second network device.

In another implementation, the apparatus for transmitting and receiving information and the processor 910 may be configured separately; for example, the apparatus for transmitting and receiving information may be configured as a chip connected to the processor 910, and the functions of the apparatus for transmitting and receiving information are executed under control of the processor 910.

Furthermore, as shown in FIG. 9, the first network device 900 may include a transceiver 940, and an antenna 950, etc. Wherein, functions of the above components are similar to those in the related art, and shall not be described herein any further. It should be noted that the first network device 900 does not necessarily include all the parts shown in FIG. 9, and furthermore, the first network device 900 may include parts not shown in FIG. 9, and the related art may be referred to.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Sixth Aspect

The embodiments of this disclosure provide a network device, including the apparatus for transmitting and receiving information described in the embodiment of the fourth aspect. The network device is a second network device.

FIG. 10 is a block diagram of a systematic structure of the second network device of the embodiment of this disclosure. As shown in FIG. 10, a second network device 1000 may include a processor 1010 and a memory 1020, the memory 1020 being coupled to the processor 1010. Wherein, the memory 1020 may store various data, and furthermore, it may store a program 1030 for information processing, and execute the program 1030 under control of the processor 1010.

In one implementation, functions of the apparatus for transmitting and receiving information may be integrated into the processor 1010.

The processor 1010 may be configured to: transmit first configuration information to a first network device, the first configuration information being used for data collection configuration, transmit first information and/or second information to the first network device, the first information and the second information being related to data collection, wherein the first information is at least used to generate a measurement configuration, and the second information is at least used to generate a data report configuration related to the measurement and receive third information from the first network device, the third information being at least used to provide suggestions and/or feedback of the data collection configuration to the second network device.

In another implementation, the apparatus for transmitting and receiving information and the processor 1010 may be configured separately; for example, the apparatus for transmitting and receiving information may be configured as a chip connected to the processor 1010, and the functions of the apparatus for transmitting and receiving information are executed under control of the processor 1010.

Furthermore, as shown in FIG. 10, the second network device 1000 may include a transceiver 1040, and an antenna 1050, etc. Wherein, functions of the above components are similar to those in the related art, and shall not be described herein any further. It should be noted that the second network device 1000 does not necessarily include all the parts shown in FIG. 10, and furthermore, the second network device 1000 may include parts not shown in FIG. 10, and the related art may be referred to.

It can be seen from the above embodiment that the first network device serving as a base station receives the first configuration information used for data collection configuration and the first information related to data collection and at least used to generate a measurement configuration and/or the second information at least used to generate a data report configuration related to the measurement from the second network device of a higher layer network, and transmits third information at least used for suggestions and/or feedback of the data collection configuration given by the second network device to the second network device. Hence, signaling related to data collection may be provided and a mechanism of data collection may be established between the first network device serving as a base station and the second network device of a higher layer network, thereby supporting requirements of model training and other artificial intelligence/machine learning (AI/ML) applications for data.

### Embodiment of a Seventh Aspect

The embodiments of this disclosure provide a communication system, including at least one of the network device as described in the embodiment of the fifth aspect, the network device as described in the embodiment of the sixth aspect and a terminal equipment.

For example, reference may be made to FIG. 1 for a structure of the communication system.

As shown in FIG. 1, the communication system 100 includes the first network device 101, the second network device 102 and the terminal equipment 103. The first network device 101 is identical to the network device described in the embodiment of the fifth aspect, and the second network device 102 is identical to the network device described in the embodiment of the sixth aspect, with repeated contents being not going to be described herein any further.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in FIG. 7 may either correspond to software modules of procedures of a computer program, or correspond to hardware modules. Such software modules may respectively correspond to the steps shown in FIG. 2. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams described in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to the implementations including the above embodiments, following supplements are further disclosed.

1. A method for transmitting and receiving information, the method including:
receiving first configuration information by a first network device from a second network device, the first configuration information being used for data collection configuration; and
receiving first information and/or second information by the first network device from the second network device, the first information and the second information being related to data collection.

2. The method according to supplement 1, wherein the method further includes:
transmitting third information by the first network device to the second network device, the third information being at least used for a suggestion and/or feedback of the data collection configuration given by the second network device.

3. The method according to supplement 1 or 2, wherein,
the first information is related to measurement content,
and the second information is related to a measurement result and/or data.

4. The method according to supplement 2, wherein,
the third information includes information of the first network device and/or a request for configuration information for configuring data collection,
and the information of the first network device includes one or more pieces of data information, model information or capability information of the first network device.

5. The method according to supplement 1, wherein,
the first information includes N binary bits, each bit indicates location information, and when the bit is a specific value, it indicates that the second network device configures the first network device to acquire a measurement result to which the location information indicated by the bit corresponds.

6. A method for transmitting and receiving information, the method including:
transmitting first configuration information by a second network device to a first network device, the first configuration information being used for data collection configuration; and
transmitting first information and/or second information by the second network device to the first network device, the first information and the second information being related to data collection.

7. The method according to supplement 6, wherein the method further includes:
receiving third information by the second network device from the first network device, the third information being at least used to provide a suggestion and/or feedback of the data collection configuration to the second network device.

8. The method according to supplement 6 or 7, wherein,
the first information is related to measurement content,
and the second information is related to a measurement result and/or data.

9. The method according to supplement 7, wherein,
the third information includes information of the first network device and/or a request for configuration information for configuring data collection,
and the information of the first network device includes one or more pieces of data information, model information or capability information of the first network device.

10. The method according to supplement 1, wherein,
the first information includes N binary bits, each bit indicates location information, and when the bit is a specific value, it indicates that the second network device configures the first network device to acquire a measurement result to which the location information indicated by the bit corresponds.

1. An apparatus for transmitting and receiving information, provided in a first network device, the apparatus comprising:
a first receiver configured to receive first configuration information from a second network device, the first configuration information being used for data collection configuration, and receive first information and/or second information from the second network device, the first information and the second information being related to data collection, the first information is at least used to generate a measurement configuration, and the second information is at least used to generate a data report configuration related to the measurement; and
a first transmitter configured to transmit third information to the second network device, the third information being at least used for a suggestion and/or feedback of the data collection configuration given by the second network device.

2. The apparatus according to claim 1, wherein,
a measurement result and/or data obtained by the first network device according to the first information and/or the second information are used for a wireless communication artificial intelligence/machine learning (AI/ML) application.

3. The apparatus according to claim 1, wherein,
the measurement is measurement related to a wireless channel performed by a terminal equipment configured by the first network device,
the measurement configuration is related to content of the measurement, and the measurement configuration is generated at least by the first network device according to the first information, the content of the measurement at least comprising a measurement metric,
and the data report configuration is related to a means on how the first network device configures the terminal equipment to transmit a measurement result and/or data to the first network device, the means being generated at least by the first network device according to the second information.

4. The apparatus according to claim 3, wherein,
the measurement metric is one or more of the following:
RSRP, RSRQ, an SINR, a TDOA, a TOA, an AoA, a channel LOS/NLOS probability, a maximum value of RSRP, a maximum value of RSRQ, a maximum value of an SINR, a maximum value of a TDOA, a maximum value of a TOA, a maximum value of an AoA, a maximum value of a channel LOS/NLOS probability, a minimum value of RSRP, a minimum value of RSRQ, a minimum value of an SINR, a minimum value of a TDOA, a minimum value of a TOA, a minimum value of an AoA, a minimum value of a channel LOS/NLOS probability, a mean value of RSRP, a mean value of RSRQ, a mean value of an SINR, a mean value of a TDOA, a mean value of a TOA, a mean value of an AoA, a mean value of a channel LOS/NLOS probability, a median value of RSRP, a median value of RSRQ, a median value of an SINR, a median value of a TDOA, a median value of a TOA, a median value of an AoA, a median value of a channel LOS/NLOS probability, other statistical values of RSRP, other statistical values of RSRQ, other statistical values of an SINR, other statistical values of a TDOA, other statistical values of a TOA, other statistical values of an AoA, or other statistical values of a channel LOS/NLOS probability.

5. The apparatus according to claim 1, wherein,
the third information is used for the second network device to generate a data collection configuration, a content of a generated data collection configuration comprising at least one of contents of updated first configuration information, updated first information or updated second information, or maintaining original configuration information unchanged.

6. The apparatus according to claim 1, wherein,
the first transmitter further transmits fourth information to a terminal equipment after the first network device receives the first information,
and the first receiver further receives fifth information from the terminal equipment,
the fourth information is used to instruct the terminal equipment to transmit the fifth information to the first network device, and/or, the fourth information indicates a content of the fifth information, the indicated content comprising at least one piece of the following information: model identification information, functionality identification information, or information on a feature and/or a feature group related to a model or functionality,
and the fifth information comprises capability information related to AI/ML of the terminal equipment and/or condition information on performing data collection related to AI/ML of the terminal equipment.

7. The apparatus according to claim 1, wherein the apparatus further comprises a first processing circuitry configured to generate the third information according to one or more of the first information, the second information or the fifth information.

8. The apparatus according to claim 1, wherein,
the second information comprises a means for reporting data, the data come from a terminal equipment and the data are acquired by the terminal equipment via wireless channel measurement according to configuration information of the first network device.

9. The apparatus according to claim 8, wherein,
the means for reporting data comprises aggregated reporting and/or periodic reporting and/or reporting according to a logging pattern.

10. The apparatus according to claim 1, wherein,
the first configuration information comprises existing measurement content, and the first information comprises measurement content different from the existing measurement content.

11. The apparatus according to claim 1, wherein,
the first information specifies measurement content via a bitmap.

12. The apparatus according to claim 11, wherein,
the first information is transmitted as an optional part of the first configuration information, or the first information is transmitted separately and not transmitted with the first configuration information.

13. The apparatus according to claim 1, wherein,
the first transmitter further transmits sixth information to the second network device,
the sixth information being used to request the second network device to initiate a data collection process and/or perform data collection configuration, the process and the configuration being used for wireless communication artificial intelligence/machine learning (AI/ML) or other applications.

14. An apparatus for transmitting and receiving information, provided in a second network device, the apparatus comprising:
a second transmitter configured to transmit first configuration information to a first network device, the first configuration information being used for data collection configuration, and transmit first information and/or second information to the first network device, the first information and the second information being related to data collection, the first information is at least used to generate a measurement configuration, and the second information is at least used to generate a data report configuration related to the measurement; and
a second receiver configured to receive third information from the first network device, the third information being at least used to provide a suggestion and/or feedback of the data collection configuration to the second network device.

15. The apparatus according to claim 14, wherein,
the measurement is measurement related to a wireless channel performed by a terminal equipment configured by the first network device,
the measurement configuration is related to content of the measurement, and the measurement configuration is generated at least by the first network device based on the first information, the content of the measurement at least comprising a measurement metric,
and the data report configuration is related to a means on how the first network device configures the terminal equipment to transmit a measurement result and/or data to the first network device, the means being generated at least by the first network device based on the second information.

16. The apparatus according to claim 14, wherein,
the third information is used for the second network device to generate a data collection configuration, a content of a generated data collection configuration comprising at least one of contents of updated first configuration information, updated first information or updated second information, or maintaining original configuration information unchanged.

17. The apparatus according to claim 14, wherein,
the second information comprises a mode for reporting data, the data come from a terminal equipment and the data are acquired by the terminal equipment via wireless channel measurement according to configuration information of the first network device.

18. The apparatus according to claim 17, wherein,
the means for reporting data comprises aggregated reporting and/or periodic reporting and/or reporting according to a logging pattern.

19. The apparatus according to claim 14, wherein,
the first configuration information comprises existing measurement content, and the first information comprises measurement content different from the existing measurement content.

20. The apparatus according to claim 14, wherein,
the second receiver further receives sixth information from the first network device,
the sixth information being used to request the second network device to initiate a data collection process and/or perform data collection configuration, the process and the configuration being used for wireless communication artificial intelligence/machine learning (AI/ML) or other applications.
